(19) United States
(12) Patent Application Publication
(10) Pub. No.: US 2010/0028549 A1
(43) Pub. Date: Feb. 4, 2010

(54) Dispersion Strengthened Rare Earth Stabilized Zirconia

(75) Inventors: Kevin W. Schlichting, Storrs, CT (US); Paul H. Zajchowski, Enfield, CT (US)

Correspondence Address: BACHMAN & LAPOINTE, P.C. (P&W), 900 CHAPEL STREET, SUITE 1201, NEW HAVEN, CT, 06510-2802, US

(73) Assignee: UNITED TECHNOLOGIES CORPORATION, Hartford, CT (US)

(21) Appl. No.: 12/183,520

(22) Filed: Jul. 31, 2008

(51) Int. Cl. B05D 1/08

(52) U.S. Cl. 427/454; 427/453

(57) ABSTRACT

In a process for forming a coating on a substrate, a rare earth oxide stabilized zirconia composition is provided. At least one additional constituent is provided comprising titania stabilized with zirconia. The rare earth oxide stabilized zirconia composition and additional constituent are blended to form a blended material. The blended material is deposited onto the substrate.

### BACKGROUND

The present disclosure relates to a ceramic coating containing dispersion strengthened rare earth stabilized zirconia to be applied to a turbine engine component and a method for forming such a coating.

Ceramic thermal barrier coatings have been used for decades to extend the life of combustors and high turbine stationary and rotating components.

As current engine models continue to increase temperatures and warrant decreased component weight, advanced ceramics are being pursued. A zirconia based coating, such as a gadolinia-zirconia coating as described in commonly owned U.S. Pat. No. 6,177,200 has been developed which provides a reduced thermal conductivity ceramic thermal barrier coating. U.S. Pregrant Publication 20060024513A1 discloses the addition of titania to a rare earth stabilized zirconia-based coating. The disclosure of U.S. Pregrant Publication 20060024513A1 is incorporated by reference in its entirety herein as if set forth at length.

### SUMMARY

With reference to the basic example of a titania additive, yet further improvements may be obtained by stabilizing the titania in the additive with zirconia. Accordingly, one aspect of the disclosure involves a process for forming a coating on a substrate. A rare earth oxide stabilized zirconia composition is provided. At least one additional constituent is provided comprising titania stabilized with zirconia. The rare earth oxide stabilized zirconia composition and additional constituent are blended to form a blended material. The blended material is deposited onto the substrate.

### BRIEF DESCRIPTION OF THE DRAWINGS

FIG. 1 is a sectional view of coated substrate.

FIG. 2 is a flowchart of a process for coating the substrate of FIG. 1.

Like reference numbers and designations in the various drawings indicate like elements.

### DETAILED DESCRIPTION

A low thermal conductivity coating is provided which utilizes a dispersion strengthening mechanism. The coating includes at least two powders that are blended mechanically, alloyed, or by other means, prior to being deposited onto a substrate, such as a turbine engine component. As used herein, the term “blended” refers to blending, mixing, and/or combining the at least two powders.

The first powder used to form the coating is a composition which contains at least one rare earth oxide, such as gadolinium oxide (gadolinia), yttrium oxide (yttria), and zirconium oxide (zirconia). The rare earth oxide or oxides in the first powder are preferably present in a minimum concentration of 5.0 wt % total. When used in the first powder, gadolinia may be present in an exemplary amount ranging from 10.0 wt % to 80 wt % (more narrowly, 35-60 wt %). When used in the first powder, yttria may be present in an exemplary amount ranging from 4.0 wt % to 25.0 wt % (more narrowly 4-10 wt %). When used in the first powder, zirconia may essentially represent the balance of the powder composition (or may be 33-58 wt %).

The first powder may contain additional rare earth constituents including, but not limited to lanthanum oxide, cerium oxide, praseodymium oxide, neodymium oxide, promethium oxide, samarium oxide, europium oxide, terbium oxide, dysprosium oxide, holmium oxide, erbium oxide, thulium oxide, ytterbium oxide, lutetium oxide, and mixtures thereof. Other oxides which may be used in the first powder composition may include at least one of iridium oxide and scandium oxide. One or more of these oxides may be used in lieu of yttria oxide or in addition thereto. The iridium oxide and/or scandium oxide may be present in an amount ranging from 10 wt % to 80 wt %.

In one example, the first powder composition consists essentially of 40 wt % gadolinia, 7 wt % yttria, and the balance zirconia. In another example, the first powder composition consists essentially of 55 wt % gadolinia, 7 wt % yttria, and the balance zirconia.

The first powder is blended mechanically, alloyed, or by other means, with a second powder comprising titania stabilized with zirconia. In a first group of examples, the second powder may consist essentially of the titania stabilized with zirconia. In one particular example, the titania stabilized with zirconia may consist essentially of an exemplary 39 wt % titania and 61 wt % zirconia. Among possible additional components of the second powder is yttria. In a second group of examples, the second powder comprises up to 10 wt % (more narrowly, 1.0-10.0 wt % or 1.0-5.0 wt %) yttria which further stabilizes the titania. In a second particular example, the second powder consists essentially of 1 wt % yttria, 41 wt % titania, balance zirconia. More broadly, the second powder may comprise at least 45 wt % zirconia and at least 25 wt % titania; or at least 55 wt % zirconia and at least 30 wt % titania.

In various implementations, the first two powders may be mixed with a third fugitive diluent powder, such as a polymer, to alter the coating microstructure by increasing porosity. Exemplary fugitive diluents are polyester or acrylic resin (LUCITE) powder, where the fugitive diluent powder has a particle size in the range from 10.0 to 250 microns. The added fugitive diluent can produce coatings with a significant reduction in thermal conductivity as compared to coatings without fugitive diluent. When used, the added fugitive diluent powder may be present in an amount ranging from 1.0 wt % to 20 wt %. The increased porosity may provide increased abradeability which may be useful in situations such as blade outer airseals (BOAS) or adjacent blade tips which may come into contact in operation.

Both the first and second powders may each have a particle size in the range of from 5.0 to 250 microns, preferably in the range of from 10.0 microns to 125 microns.

The first and second powders may be blended so that the first powder forms from 50 wt % to 95 wt % of the coating powder (more narrowly, 85-92 wt %) and the second powder forms from 5 wt % to 50 wt % of the coating powder (more narrowly, 8-15 wt %). In a particular embodiment, the first powder is present in the amount of 90 wt % and the second powder is present in the amount of 10 wt %.

As mentioned above, the blending of the two or more powders may be a mechanical blending or be prepared by other means such as, but not limited to, plasma densification, fused and crushed, spray dried/sintered, and spray dried/plasma densified. For example, the powders may be mixed by combining the two powders, in the appropriate concentrations, into a closed chamber, such as a jar or powder blender, and mixing for an appropriate time (e.g., minutes). The powder may be mixed just prior to filling the plasma-spray powder feeder mechanism to ensure a uniform powder mixture for a uniform coating. However the powder could be mixed and stored for an indefinite period of time. Prior to spraying, the powder could be sufficiently re-mixed to eliminate any settling effects and ensure a uniform powder distribution.

After the blending operation has been completed, the two powders may be deposited on a substrate using any suitable technique known in the art. For example, the powder may be plasma spray deposited on the substrate or may be applied using thermal spray techniques. Alternatively, the powder may be formed into a gravel or ingot material for deposition such as electron beam physical vapor deposition (EBPVD). In an exemplary EBPVD process, the two powders are mixed and pressed and sintered to form a ceramic ingot. The ingot may be placed into the feedstock system of the EBPVD coater and evaporated to form a ceramic vapor. The ceramic vapor will condense on the relatively cool substrate (which may be rotated in the vapor) to form a ceramic coating.

Articles which can be provided with the coatings of the present invention include, but are not limited to, combustor components, high pressure turbine vanes and blades, tips, cases, nozzles, and seals.

The coatings may be applied to any component of an engine requiring a thermal barrier coating/abradable system or a clearance control system.

The coatings are sometimes called dispersion strengthened coatings because they contain a dispersed second phase which improves coating toughness. Depending upon the selected composition, the present coatings may have one or more advantages over prior art coatings. The strengthening may improve the fracture toughness of the coating. This improvement may benefit properties such as spallation resistance and erosion resistance. Specifically, the stabilization of the titania by zirconia (and optionally yttria) stabilizes the crystal structure in at least a portion of the operating temperature range of the coating. The stabilized crystal structure reduces phase transformation. By reducing phase transformation, residual stress build-up associated with phase transformation is reduced.

Another possible advantage is improved performance relative to molten sand attack (also known as CMAS). CMAS is an acronym for “calcium-magnesium-aluminum-silicon (silicate)”. At typical gas turbine engine operating temperatures, CMAS becomes molten in the combustor section and the high pressure turbine (HPT) section of the engine. The molten CMAS wets, wicks into, and chemically attacks thermal barrier coatings. In the present coatings, the elements of the second powder may combine with the molten CMAS and provide a net composition that remains solid (thereby not continuing penetration and chemical attack).

If desired, the article containing the coating may have one or more additional layer(s). For example, an additional layer may be deposited directly on the substrate, beneath the coating formed by the blended powders (e.g., as a bond coat). As is discussed further below, exemplary bond coats may be ceramic or may be metallic. Alternatively, or additionally, there may be an additional layer deposited on top of the coating (e.g., as a sealing coat). In exemplary systems, the subject coating may be the thickest layer of the total coating system and may represent at least 50% of the total coating thickness (whether locally measured or measured as an appropriate average such as mean, median, or mode).

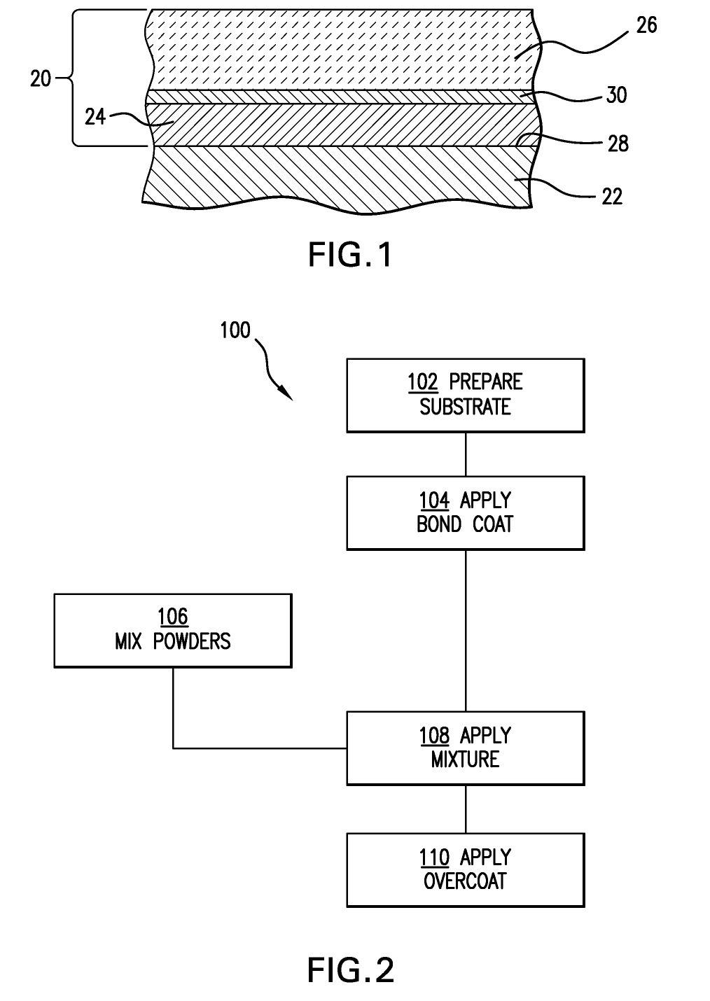

FIG. 1 shows a coating system 20 atop a superalloy substrate 22. The system may include a bond coat 24 atop the substrate 22 and a TBC 26 atop the bond coat 24. In an exemplary process, the bond coat 24 is deposited atop the substrate surface 28. A TGO 30 may form at the interface.

One exemplary metallic bond coat is a MCrAlY (where M is Ni, Co, Ni/Co, or Fe) which may be deposited by a thermal spray process (e.g., air plasma spray, high velocity oxy-fuel (HVOF), or low pressure plasma spray) or by an electron beam physical vapor deposition (EBPVD) process such as described in U.S. Pat. No. 4,405,659. An alternative bond coat is a diffusion aluminide deposited by vapor phase aluminizing (VPA) as in U.S. Pat. No. 6,572,981. An exemplary characteristic (e.g., mean or median) bond coat thickness is 4-9 mil (100-230 μm).

Other alternative bond coat materials include ceramics. an exemplary single layer ceramic bondcoat is 7YSZ. A combination bond coat comprises a metallic base layer and ceramic layer atop the base layer. For example, the bondcoat may comprise an MCrAlY base layer and a ceramic (e.g., 7YSZ) atop the base layer.

An exemplary process 100 includes preparing 102 the substrate (e.g., by cleaning and surface treating). The bond coat is applied 104. The first and second powders are mixed 106 and applied 108. An overcoat (if any) may then be applied 110. An exemplary overcoat is a chromia-alumina combination as disclosed in U.S. Pat. No. 6,060,177.

Increased erosion and molten sand resistance may yield longer component life for components in the combustor and turbine sections. A lower thermal conductivity, if present, may enable higher operating temperatures resulting in improved turbine efficiency.

One or more embodiments have been described. Nevertheless, it will be understood that various modifications may be made. For example, and applied as a reengineering of an existing component, details of the existing component may influence or dictate details of any particular implementation. Accordingly, other embodiments are within the scope of the following claims.

What is claimed is:

1. A process for forming a coating on a substrate comprising:
providing a rare earth oxide stabilized zirconia composition;
providing at least one additional constituent comprising titania stabilized with zirconia;
blending said rare earth oxide stabilized zirconia composition with said least one additional constituent to form a blended material; and
depositing said blended material onto said substrate.

2. A process according to claim 1, wherein said rare earth oxide stabilized zirconia composition comprises a gadolinia, yttria, and zirconia composition.

3. A process according to claim 1, wherein said rare earth oxide stabilized zirconia composition comprises a powder having a composition of from 10 wt % to 80 wt % gadolinia, from 4.0 wt % to 25 wt % yttria, and the balance zirconia.

4. A process according to claim 1, wherein said rare earth oxide stabilized zirconia composition comprises a powder having a composition of 35-60 wt % gadolinia, 4-10 wt % yttria, and 33-58 wt % zirconia.

5. A process according to claim 1, wherein said rare earth oxide stabilized zirconia composition comprises a powder having a composition of 40 wt % gadolinia, 7 wt % yttria, and 53 wt % zirconia.

6. A process according to claim 1, wherein said rare earth oxide stabilized zirconia composition comprises a powder having a composition of 55 wt % gadolinia, 7 wt % yttria, and 38 wt % zirconia.

7. A process according to claim 1, wherein said blended material comprises:
at least 60 wt % said rare earth oxide stabilized zirconia composition; and
at least 5 wt % said titania stabilized with zirconia.

8. A process according to claim 7, wherein said blended material comprises:
at least 80 wt % said rare earth oxide stabilized zirconia composition; and
at least 7 wt % said titania stabilized with zirconia.

9. A process according to claim 7, wherein said titania stabilized with zirconia comprises:
at least 45 wt % said zirconia; and
at least 25 wt % said titania.

10. A process according to claim 1, wherein said titania stabilized with zirconia comprises:
at least 45 wt % said zirconia; and
at least 25 wt % said titania.

11. A process according to claim 10 wherein said titania stabilized with zirconia further comprises up to 10 wt % yttria.

12. A process according to claim 1, wherein said at least one additional constituent comprises 1.0-20 wt % fugitive diluent.

13. A process according to claim 12, wherein said fugitive diluent consists essentially of a polymer powder.

14. A process according to claim 1, wherein said depositing comprises:
depositing said blended material directly onto said substrate, said substrate being a metal alloy.

15. A process according to claim 1, wherein said depositing comprises:
plasma spraying said blended material onto said substrate.

16. A process according to claim 1, further comprising:
depositing a bondcoat onto said substrate, said blended material being deposited to the substrate via the bondcoat.

17. A process according to claim 16, wherein:
said depositing said bondcoat onto said substrate comprises depositing a metallic bondcoat.

18. A process according to claim 16, wherein:
said depositing said bondcoat onto said substrate comprises depositing a ceramic bondcoat.

19. A process according to claim 16, wherein:
said depositing is to a thickness of at least 0.5 mm.

20. A coated substrate produced according to the process of claim 1.

21. A process for forming a coating on a substrate comprising:
providing a rare earth oxide stabilized zirconia composition;
providing at least one additional constituent comprising titania stabilized with zirconia;
blending said rare earth oxide stabilized zirconia composition with said least one additional constituent to form a blended material; and
depositing said blended material onto said substrate.
